(19) United States
(12) Patent Application Publication
(10) Pub. No.: US 2005/0183598 A1
(43) Pub. Date: Aug. 25, 2005

(54) Ink form roller drive for improving printing quality

(75) Inventors: Scott R. Johnson, Arlington, TX (US); Michael J. Barisonek, Arlington, TX (US)

Correspondence Address: BURNS DOANE SWECKER & MATHIS L L P, POST OFFICE BOX 1404, ALEXANDRIA, VA, 22313-1404, US

(73) Assignee: Epic Products International Corporation, Arlington, TX (US)

(21) Appl. No.: 10/782,807

(22) Filed: Feb. 23, 2004

(51) Int. Cl. B41L 23/00

(52) U.S. Cl. 101/423

(57) ABSTRACT

An apparatus and method for improving print quality in a rotary offset press includes a variable speed servo motor for selectively applying a driving or braking action to a form roller in contact with a plate cylinder. The servo motor may be directly coupled to the form roller by a belt drive independent of the press drive and controlled to maintain a selected surface speed differential between the plate cylinder and the form roller during printing.

### FIELD OF THE INVENTION

The present invention relates to printing devices and methods, especially those used in inkers for rotary offset printing presses.

### BACKGROUND OF THE INVENTION

An offset printing press typically includes a plate cylinder carrying a printing plate. The printing plate has oleophilic surfaces defining an image area, and hydrophilic surfaces defining a non-image area. An inker applies ink to the printing plate which collects on the oleophilic surfaces to form an image which is transferred to a blanket cylinder and which, in turn, is transferred to the media such as a web of paper, plastic or metal. By transferring the image from the printing plate onto a blanket roller, and then onto the media, the printing plate does not directly print the image on the media, hence the term “offset” printing.

Inkers of various constructions are known in the art. The inker applies ink carried on one or more form rollers to the printing plate. An example of an inking system is shown, for example, in U.S. Pat. No. 6,571,710 to Price.

A problem associated with conventional printing systems is the presence or accumulation of foreign particles on the printing plate during printing. These particles are sometimes referred to as “hickeys,” and may degrade the image transferred to the media during printing.

An approach to solving the problems of foreign particles on the printing plate is discussed in U.S. Pat. No. 3,467,008 to Domotor. In the Domotor system, a first ink form roller is driven by a gear drive at a surface speed different relative to the surface speed of the plate cylinder. As a result of such surface speed differential, the surfaces of the plate cylinder and form roller wipe over each other and particles of foreign matter (such as lint, paper bits, or dry ink particles) are wiped off of the plate cylinder. The particles are transported along the ink roller train away from the plate cylinder.

Domotor discloses a particular gear drive system which would increase the initial cost and complexity of the press design. A surface speed differential in Domotor is obtained by gear ratio selection and selection of diameters of the rollers, including the driver inking rollers. Limitations and disadvantages of the Domotor system are addressed by the ink form roller drive and controlling methods discussed below.

### SUMMARY OF THE PREFERRED EMBODIMENTS

An embodiment of the present invention is an apparatus for removing foreign particles from the plate(s) of a rotary offset press. Such a press has at least one plate cylinder rotated by a press drive and one or more form rollers normally in rotational contact with the plate cylinder. The apparatus includes a variable speed servo motor separate from the press drive and coupled to at least one of the form rollers. A controller is provided for the variable speed servo motor, which controller is settable to maintain selected different surface speed differentials between the form roller and the plate cylinder. The apparatus may further include sensors for sensing the speed of at least one of the plate cylinder, driven form roller and/or the press drive. The sensed speed is used by the controller to maintain a selected surface speed ratio.

In a preferred embodiment of the apparatus, the variable speed servo motor is directly coupled to the first form roller to apply ink to the plate cylinder after it contacts the blanket cylinder. The apparatus may be adapted to retrofit an existing press having at least one form roller, particularly a press which, in an unmodified state, has a form roller indirectly driven by frictional engagement to another roller, especially the plate cylinder. Preferably, in accordance with the invention, the form roller is directly coupled to the variable speed servo motor by a belt drive or gear drive.

In a preferred embodiment of the present invention, a constant surface speed differential is maintained between the first form roller and the plate cylinder even when the press speed varies during normal printing operation. One of the selectable surface speed ratios is 1:1. The variable speed servo motor may selectively drive the form roller at a higher, lower or equal surface speed with respect to the surface of the plate cylinder. At least one roller temperature sensor may be provided and the surface speed ratio controlled responsive to the sensed roller temperature. The variable speed servo motor may selectively apply a driving torque to speed up the form roller or a braking torque to slow down the form roller.

The controller may be programmed to select different surface speed differentials responsive to press operating modes. Advantageously, the modes may include a printing mode in which the speed differential between the form roller and plate cylinder is maintained at an optimum value, for example 80 feet per minute. In one embodiment, speeds are varied to produce a constant speed differential, regardless of press speed. In other modes, for example, wash-up mode, no surface speed differential may be produced.

The present invention also includes methods for removing foreign particles from the plate cylinder of a press being inked by at least one form roller. In preferred embodiments of the method, the plate cylinder is driven directly or indirectly by a press drive. The speed of rotation of the plate cylinder is sensed by an appropriate sensor. The form roller is placed in pressural rotational contact with the plate cylinder to apply ink thereto. The speed of the at least one form roller is varied with a servo motor. The speed of the form roller is sensed and a torque is applied to the form roller with the servo motor based on the sensed speeds of rotation of the plate cylinder and the at least one form roller to produce a speed differential between the form roller and the plate cylinder to thereby remove foreign particles from the plate cylinder. Preferably, the selected speed differential is between 40 ft/min and 120 ft/min, more preferably between 60 ft/min to 100 ft/min, most preferably 80 ft/min.

In a selectable wash-up mode, the form roller may be controlled to produce little or no surface speed differentials with respect to the plate cylinder. Various surface speed differential may be produced by either driving the form roller or dynamically braking the form roller with the servo motor.

Some or all of these features may be included in embodiments of the present invention as set out in the following detailed description, drawings and claims.

### BRIEF DESCRIPTION OF THE DRAWINGS

FIG. 1 is a diagrammatic and schematic side elevation of a rotary printing press and electronic control system therefor.

FIG. 2 is a diagrammatic and schematic front elevation of a portion of the rotary printing press of FIG. 1 and electronic control system therefor.

### DETAILED DESCRIPTION OF THE PREFERRED EMBODIMENT

Preferred embodiments of the present invention are designed to improve print quality in rotary presses, particularly offset presses having a plate cylinder rotated by a press drive and at least one roller for applying ink to the plate cylinder. In such presses, the ink-applying roller may be in adjustable pressural rotational contact with the plate cylinder during printing. A variable speed servo motor is employed for applying a selectable driving or braking action to the ink-applying roller. A sensor, such as an optical encoder, is provided for sensing the speed of the plate cylinder, form roller and/or the press drive. A controller for the variable speed servo motor maintains a selected surface speed differential between the plate cylinder and the at least one ink applying roller.

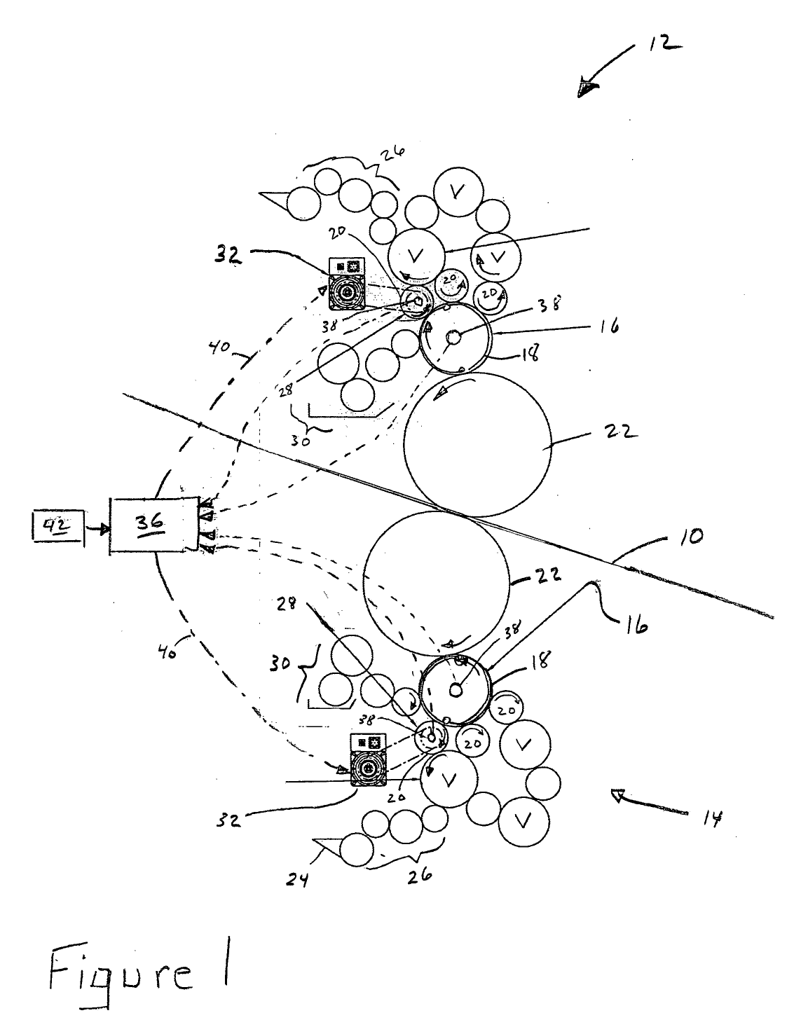

In FIG. 1, an embodiment of a rotary offset printing press for two-sided printing is shown, it being understood that conventional offset rotary presses can take many other forms. The printing is performed on a moving media 10. Upper and lower printing assemblies 12 and 14 of the press are substantially identical in structure and function.

Each printing assembly 12, 14 includes a plate cylinder 16 carrying one or more printing plates 18 bearing images for printing on the media. The image areas of the plates receive ink from one or more form rollers 20. The plate cylinders 16 are rotated to engage the printing plates 18 with rotatably mounted blanket cylinders 22. Inked images are transferred onto the blanket cylinders and the blanket cylinders then transfer the inked images to the media which is pinched between the blanket cylinders. The directions of rotation of the blanket cylinders, plate cylinders and form rollers are indicated by the curved arrows in the figure.

In the embodiment of FIG. 1, ink is provided to the form rollers from upper and lower ink fountains 24 through ink application roller trains 26. From the roller train, ink is supplied to the form rollers 20 by a further series of vibrating roller (indicated by the letter “V”) in contact with transfer rollers.

Form rollers 28 are the first rollers to apply ink to the plate cylinders 18 after the plate cylinders contact the blanket cylinders 22. Dampening systems 30 may be provided to apply dampening fluid to the plate cylinders 18. It will be understood by those skilled in the art that the particular construction of the press will vary depending on many design factors. For example, various roller arrangements may be employed to ink the plate cylinder, including systems having single and multiple form rollers. The invention herein is not intended to be limited to particular inkers or press arrangements except as otherwise expressly stated in the claims.

In a preferred embodiment of the present invention, an existing press having the form roller(s), inking roller(s), plate cylinder(s) and blanket cylinder(s) maybe retrofitted to provide speed control for removing foreign particles from the plate cylinder and thereby improving printing quality. Variable speed servo motor drives 32 may be employed to control the speed of the first form rollers 28 relative to the press speed or plate cylinder surface speed. Alternatively, the variable servo motor drive and control can be provided as original equipment on the press.

The variable speed servo motor drives 32 may be AC servo drives and provide added torque or braking action to the form rollers especially the first form rollers 28. In one embodiment, the variable speed servo motor drives 32 are directly coupled to the form rollers by drive belts or drive chains 34, especially toothed belt drives. Alternatively, the direct coupling can be affected with a gear drive (not shown).

A controller 36 is used to control the variable speed servo motor drives 32. Speed sensors such as optical encoders 38 may be used to sense the speed of the plate cylinder, form rollers and press drives. Signals from the speed sensors (indicated by broken lines) may be applied to the controller 36. The controller applies a control signal (broken lines 40) to the variable speed servo motor drives to maintain a selected surface speed differential between the plate cylinders and the form rollers 28. A differential speed selector 42 may be employed by the press operator to select the desired speed differential in accordance with the current mode of operation of the press or (in the case of wash-up mode) to select no speed differential.

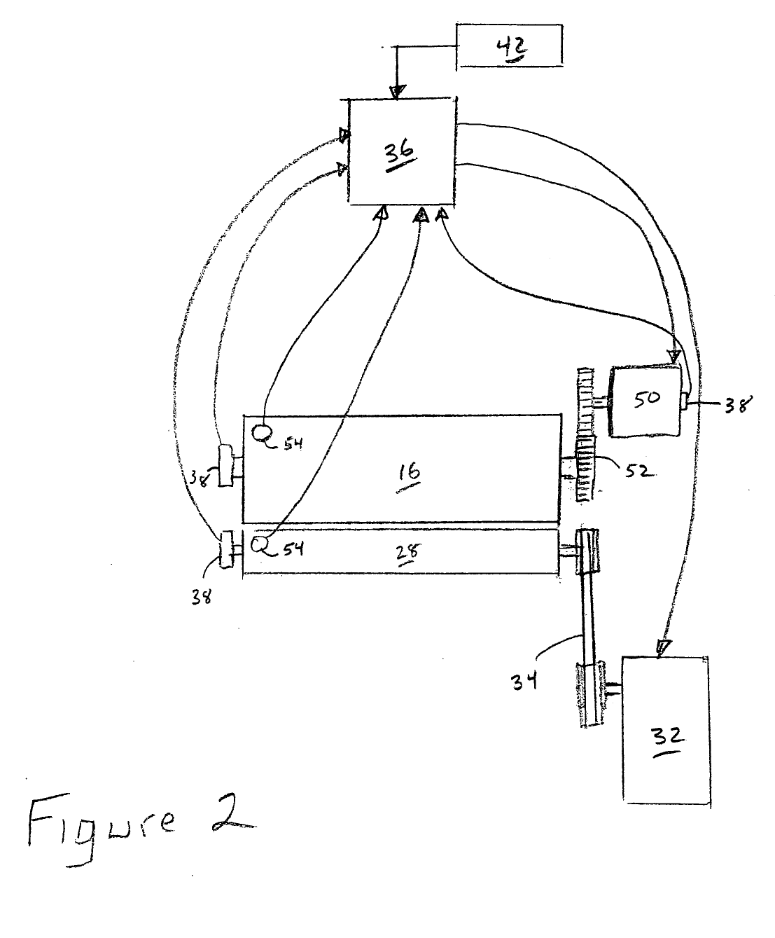

FIG. 2 is a diagrammatic and schematic front elevation of a portion of the rotary printing press of FIG. 1 and electronic control systems therefor. The plate cylinder 16 and form roller 28 are shown in rotational contact in the figure. Advantageously, the form roller 28 is selectively positionable with respect to the plate cylinder to adjust the nip therebetween. In a preferred embodiment, the drive applied to the form roller is adaptable to the repositioning of form roller. In addition, the selected driving system can be adapted to various press constructions and roller movements so that the driving system can be used to retrofit various kinds of existing presses.

With continuing reference to FIG. 2, the plate cylinder is shown as driven by a press drive motor 50 and gear train 52. The variable speed servo motor 32 varies the speed of the form roller 28 using belt drive 34 which can adapt to positional adjustments made to the form roller.

Optical encoder speed sensors 38 provide signals to controller 36 which are indicative of the rotational speeds of the form roller and plate cylinder. Optionally, infrared temperatures sensors 54 may be used to sense the temperatures of the form roller and plate cylinder. The controller 36 processes the signals from the sensors 38 and 54 and controls signals from the differential speed selector 42, and provides control signals to the press drive 50 and/or variable speed servo motor 32. The speed of the press may be determined by the operator and/or adjusted to maintain sensed roller temperatures within a desirable range. The controller can maintain a selected speed differential (regardless of actual press speed) by controlling the variable speed servo motors 32 to speed up or dynamically brake the rotation of the form roller 28.

An example of possible design and operating parameters of a press employing the teachings of the present invention is as follows. A sheet fed printing press with a plate cylinder diameter of 11.00 inches, printing at a speed of 10,000 sheets per hour (sph), rotates at 166.66 revolutions per minute (rpm), equaling 479.96 feet per minute (fpm). An ink form roller with a 4.00 inch diameter rotating in contact with the plate cylinder with a 1:1 speed ratio will also have a surface speed of 479.96 fpm, but will be turning at the higher rate of 458.33 rpm. To produce an optimum speed differential such as 80 fpm at this press speed, the form roller speed needs to be slowed by 80 fpm to a surface speed of 399.96 fpm, which corresponds to a rotational speed of 381.93 rpm. Thus for 1 revolution of the plate cylinder, the form roller will turn 2.29 revolutions. If the ratio 1:2.29 is fixed, any press speed variation from 10,000 sph will produce an unwanted change in the speed differential. For example, a printing speed of 5000 sph produces only 40 fpm differential if the speed ratio is constant 1:2.29. In accordance with preferred embodiments of the present invention, the surface speed differential, rather than the surface speed ratio, is maintained at a constant selected value. Because press speeds may vary depending on image, inks, stock, print mode, etc., having a fixed ratio is not conducive to maintaining an optimum speed differential. By having a controlled variable drive, optimum speed differential may be maintained at various press speeds.

While the present invention has been described by reference to preferred embodiments, it will be understood that the invention may be adapted to presses of various designs. The invention which is intended to be covered is defined by the following claims having the recited elements and equivalents thereof.

1. An apparatus for removing foreign particles from a rotary press having a plate cylinder rotated by a press drive and having at least one ink form roller normally in rotational contact with the plate cylinder, the apparatus comprising:
a variable speed servo motor separate from the press drive and directly coupled to at least one form roller which applies ink to the plate cylinder after the plate cylinder contacts a blanket cylinder of the press; and
a controller for the variable speed servo motor, which controller is settable to maintain any one of several different relative surface speeds between the first form roller and the plate cylinder.

2. The apparatus of claim 1 further comprising a sensor for sensing the speed of at least one of the plate cylinder, the driven form roller or the press drive, wherein said sensed speed is used by the controller to maintain a selected surface speed differential.

3. The apparatus of claim 1 wherein the press has multiple form rollers.

4. The apparatus of claim 3 wherein the form roller to which the variable speed servo motor is coupled is the first roller to apply ink to the plate cylinder after the plate cylinder contacts a blanket cylinder of the press.

5. The apparatus of claim 1 wherein the apparatus is adapted to retrofit an existing press.

6. The apparatus of claim 1 wherein the form roller is directly coupled to the variable speed servo motor by a belt drive.

7. The apparatus of claim 1 wherein the form roller is directly coupled to the variable speed servo motor by one of a toothed belt drive, a chain drive, a telescoping shaft drive or a gear drive.

8. The apparatus of claim 1 wherein a constant selected surface speed differential is maintained between the form roller and the plate cylinder while the press speed varies.

9. The apparatus of claim 1 wherein relative surface speeds between 40 and 120 feet per minute are selectable for printing operation and a zero surface speed differential is selectable for another press operation mode.

10. The apparatus of claim 1 further comprising at least one roller temperature sensor and wherein a surface speed differential is controlled responsive to the sensed roller temperature.

11. The apparatus of claim 1 wherein the variable speed servo motor selectively applies a braking action to the form roller.

12. The apparatus of claim 1 wherein the variable speed servo motor selectively drives the form roller at a higher surface speed than the plate cylinder.

13. The apparatus of claim 1 wherein the controller is programmed to select different surface speed differentials responsive to press operating modes.

14. The apparatus of claim 13 wherein the press operating modes and surface speed differentials include
make-ready: optimum surface speed differential;
printing: continuously varying the drive or braking to adjust for varying press speeds; and
wash-up: no surface speed differential.

15. An apparatus for improving print quality in a rotary offset press having a plate cylinder rotated by a press drive and at least one roller for applying ink to the plate cylinder, the ink-applying roller being in adjustable pressural rotational contact with the plate cylinder during printing, the apparatus comprising:
a variable speed servo motor for selectably applying a braking action to the ink-applying roller;
a sensor for sensing the speed of at least one of the plate cylinder or the press drive; and
a controller responsive to the sensor, for the variable speed servo motor for maintaining a selected surface speed differential between the plate cylinder and the at least one ink applying roller during printing.

16. The apparatus of claim 15 wherein the ink-applying roller is directly coupled to the variable speed servo motor by a belt drive.

17. The apparatus of claim 15 wherein the ink-applying roller is directly coupled to the variable speed servo motor by one of a toothed belt drive, a chain drive, a telescoping shaft drive or a gear drive.

18. The apparatus of claim 15 wherein the maintained surface speed differential is between 40 and 120 feet per minute for printing operation and a zero surface speed differential is selectable for other press operation modes.

19. A method for removing foreign particles from the plate cylinder of an offset press being inked by at least one form roller comprising the steps of:
driving the plate cylinder with the press drive;
sensing the speed of rotation of the plate cylinder;
placing the at least one form roller in pressural rotational contact with the plate cylinder to apply ink thereto;
varying the speed of the at least one form roller with a servo motor;
sensing the speed of the at least one form roller; and
applying a torque to the form roller with the servo motor based on the sensed speed of the at least one form roller to produce a speed differential between the at least one form roller and the plate cylinder to thereby remove foreign particles from the plate cylinder.

20. The method of claim 19 wherein a selected surface speed differential maintained during printing is between 40 and 120 feet per minute.

21. The method of claim 19 wherein a selected surface speed differential maintained during printing is between 60 and 100 feet per minute.

22. The method of claim 19 wherein a selected surface speed differential maintained during printing is 80 feet per minute.

23. The method of claim 19 further comprising the step of producing essentially no surface speed differential during wash-up.

24. The method of claim 19 wherein the servo motor applies dynamic braking action.
